(19) United States
(12) Patent Application Publication
(10) Pub. No.: US 2023/0383050 A1
(43) Pub. Date: Nov. 30, 2023

(54) DYNAMIC BONDS FOR DOUBLE DEGRADATION FEATURES IN POLYMERIC MATERIALS

(71) Applicant: SAUDI ARABIAN OIL COMPANY, Dhahran (SA)

(72) Inventors: Haleema Alamri, Thuwal (SA); Maryah Almaghrabi, Thuwal (SA); Aziz Fihri, Paris (FR)

(73) Assignee: SAUDI ARABIAN OIL COMPANY, Dhahran (SA)

(21) Appl. No.: 17/824,658

(22) Filed: May 25, 2022

(51) Int. Cl. C08G 63/08; C08J 11/18; C08J 11/14; C08J 11/12

(52) U.S. Cl. CPC C08G 63/08; C08J 11/18; C08J 11/14; C08J 11/12; C08J 2367/04

(57) ABSTRACT

A doubly degradable polymer composition may include one or more aliphatic polyesters and one or more imine functional groups. The imine functional groups may be incorporated into the aliphatic polyester backbone. A method of preparing a doubly degradable polymer composition may include polymerizing one or more lactone monomers to form a polylactone polymer and reacting the polylactone polymer with a bis-imine compound to incorporate one or more imine functional groups into the polylactone polymer backbone. A method of degrading a doubly degradable polymer composition may include providing a doubly degradable polymer composition including one or more ester functional groups and one or more imine functional groups and exposing the doubly degradable polymer composition to at least one of water, an elevated temperature, and soil, thereby hydrolyzing at least one cleavable covalent bond to produce an aldehyde and an amine.

### BACKGROUND

The annual accumulation of millions of tons of plastics in marine and land environments can be attributed to the inherent strong chemical bonds in plastics, generally ineffective technologies for their recycling, and the low degree of their reusage. For these reasons, a number of countries, regions, and cities have recently introduced regulations and legislation restricting the use of plastic.

Degradable polymers can be a suitable alternative. Degradable polymers are polymers that can degrade in the environment. Generally, hydrolysable groups make synthetic polymers and biopolymers degradable. The degradation mechanism in polymers proceeds mainly via hydrolysis and/or oxidation. While most degradable polymers were initially used in biomedical applications, degradable polymers are gaining importance as alternatives for many plastics.

Numerous factors can contribute to the process of polymer degradation, including the presence of hydrolysable and/or oxidizable functional groups on the polymer chain, the correct stereo configuration of the polymer, and the right balance between hydrophobicity and hydrophilicity in the polymer. On the other hand, degradation rates are also substantially affected by the morphology of the polymers.

Accordingly, there exists a need for a degradable polymer that can controllably degrade at room temperature.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a doubly degradable polymer composition the includes one or more aliphatic polyesters and one or more imine functional groups. In one or more embodiments, the doubly degradable polymer composition may include one or more imine functional groups incorporated into the aliphatic polyester backbone.

In another aspect, embodiments disclosed herein relate to a method of preparing a doubly degradable polymer composition including polymerizing one or more lactone monomers to form a polylactone polymer and reacting the polylactone polymer with a bis-imine compound to incorporate one or more imine functional groups into the polylactone polymer backbone.

In yet another aspect, embodiments disclosed herein relate to a method of degrading a doubly degradable polymer composition including providing a doubly degradable polymer composition comprising one or more ester functional groups and one or more imine functional groups and exposing the doubly degradable polymer composition to at least one of water, an elevated temperature, and soil, thereby hydrolyzing at least one cleavable covalent bond to produce an aldehyde and an amine.

Other aspects and advantages of the claimed subject matter will be apparent from the following description and the appended claims.

### BRIEF DESCRIPTION OF DRAWINGS

FIG. 1 is schematic of reaction schemes to synthesize polymers from the enzymatic ring-opening polymerization of macrolactones using an enzyme catalyst Candida Antarctica:lipase B (CALB) in accordance with one or more embodiments.

FIG. 2 is schematic of reaction scheme to synthesize a doubly degradable polymer composition in accordance with one or more embodiments.

FIG. 3 is an illustration of a structure of a doubly degradable polymer showing the cleavable bonds in accordance with one or more embodiments.

### DETAILED DESCRIPTION

Embodiments of the present disclosure generally relate to doubly degradable polymer compositions, specifically aliphatic polyester polymers with imine functional groups. The doubly degradable polymer composition includes covalent bonds that may be cleaved upon exposure to water or an oxidizing agent. Therefore, the disclosed doubly degradable polymer may degrade into aldehydes and amines upon exposure to water.

### Definitions

As used herein “degradable polymer” refers to a polymer that breaks down into monomers and/or oligomers. The degradation can occur naturally upon exposure to certain environmental conditions or can be catalyzed by living microorganisms or chemicals. A degradable polymer decomposes under heat, sunlight, and/or moisture and can degrade in the presence or absence of oxygen.

As used herein “biodegradable polymer” refers to a polymer that breaks down into monomers and/or oligomers via microorganisms such as bacteria, fungi, and algae without human intervention in the form of processing conditions or chemical additives. A biodegradable polymer requires the presence of oxygen to degrade and can naturally degrade in the environment. A biodegradable polymer may include ester, amide, or ether bonds, for example. Aliphatic polyesters such as polylactones and polylactic acids (PLAs) are non-limiting examples of biodegradable polymers.

As used herein “doubly degradable” refers to a property in which two different types of covalent bonds may be broken for polymer to degrade. In one or more embodiments of the present disclosure, the two different types of covalent bonds may be an ester bond and an imine bond.

As used herein “dynamer” refers to a constitutional dynamic polymer. Constitutional dynamic polymers are polymers whose monomeric components are linked through reversible connections. A constitutional unit refers to an atom or group of atoms in a macromolecule or oligomer molecule. Constitutional dynamic polymers have the capacity to modify their constitution by exchange and reshuffling of their constitutional units. The connections may be covalent bonds or non-covalent interactions.

As used herein “physiological conditions” refers to a temperature range of 20-40° C., an atmospheric pressure of about 1 atm, and a pH range of between 6 and 8. Physiological conditions may or may not include the presence of oxygen.

As used herein “inert environment” refers to an environment with a non-reactive atmosphere, such as nitrogen or argon gas. Inert environments may be utilized when performing reactions described herein.

### Doubly Degradable Polymer Composition

The doubly degradable polymer composition in accordance with one or more embodiments of the present disclosure may include an aliphatic polyester polymer with imine functional groups. In one or more embodiments, the imine functional groups may be incorporated into the aliphatic polyester polymer backbone using a polymerizing agent. The doubly degradable polymer is a dynamer.

### Aliphatic Polyester

An aliphatic polyester polymer is a polymer having a fundamental constituent unit including an ester bond and an aliphatic group. As used herein, an aliphatic group is hydrocarbon group that may be saturated or unsaturated and may include a suitable number of carbon atoms, to be explained in greater detail below. An example of a category of aliphatic polyesters in accordance with the present disclosure is polylactones. Polylactones are particularly advantageous because they are biodegradable polymers under physiological conditions. The ester groups facilitate polymer cleavage into monomers and oligomers. The low level of toxicity of polylactones with respect to the human body offers significant potential for their use in pharmaceutical and biomedical applications. Polylactones such as polylactide (PLA), polyglycolide (PGA), and polycaprolactone (PCL) may be used in the doubly degradable polymer composition described herein. Examples of aliphatic polyester polymers in accordance with the present disclosure are shown as Formulae (I)-(III) below.

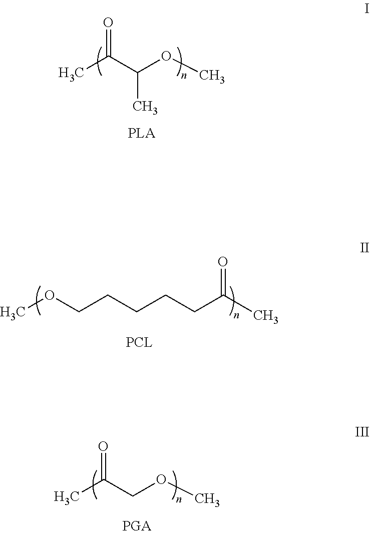

Polylactones may be obtained from small, medium, or large (macro) lactones by ring opening polymerization of lactones using a catalyst. Lactones are cyclic esters of organic acids. Examples of lactones with four, five, six, and seven carbons are show below in Formulae (IV)-(VII). As used herein, small lactones contain four to six carbon atoms, medium lactones contain seven to eleven carbon atoms, and macrolactones (ML) contain twelve to seventeen carbon atoms.

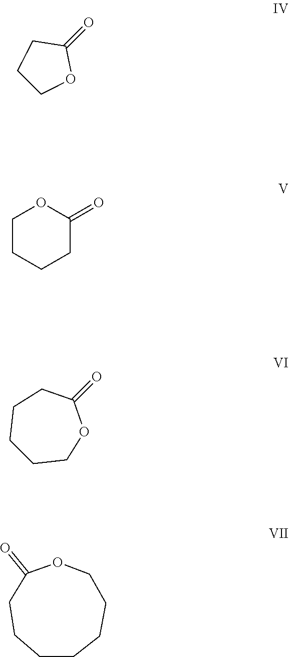 [SMILES: O=C1CCCO1 ; O=C1CCCCO1 ; O=C1CCCCCO1 ; O=C1CCCCCCCO1]

Examples of lactone monomers that may be polymerized to form a polymacrolactone include pentadecalactone and hexadecalactone. Examples of the polymacrolactone may include but are not limited to, polypentadecalactone, polyglobaltide, polyhexadecalactone, polyambrettotide, and combinations thereof. Polymers derived from MLs constitute a class of materials with promising thermal and mechanical properties that might make them suitable for applications as biomaterials, especially if metal-free polymerization catalysts are used.

A wide variety of polymacrolactones may be used to make the doubly degradable polymers. The choice of the number of carbons in the ML is dependent on the desired degradation rate of the doubly degradable polymer. As the number of carbons in the macrolactone increases, the degradation rate decreases due to the relative decrease in ester bonds in the polymer.

### Imine Functional Group

As noted above, the doubly degradable polymer in accordance with one or more embodiments of the present disclosure may include an aliphatic polyester polymer with imine functional groups. An imine (C═N) functional group may be incorporated into an aliphatic ester polymer as a second cleavable covalent bond by reacting an aliphatic polyester with a bis-imine compound.

In one or more embodiments, the imine functional group may be introduced into the aliphatic polyester polymer backbone by polymerizing the polymacrolactone with a bis-imine compound in the presence of a polymerizing agent. The bis-imine compound in one or more embodiments may be aliphatic or aromatic.

In accordance with embodiments of the present disclosure, the bis-imine compound may be aromatic. Aromatic bis-imine compounds are particularly useful for controlling the hydrolysis when the doubly degradable polymer is in contact with water. Specifically, the rate of hydrolysis tends to decrease with an increase in size of the aromatic bis-imine compound. Thus, suitable bis-imines may be chosen based on the desired relative rate of hydrolysis. An example of a structure of the bis-imine compound used in one or more embodiments is depicted in Formula VIII.

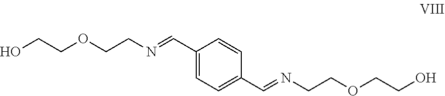 [SMILES: OCCOCC/N=C/c1ccc(/C=N/CCOCCO)cc1]

### Doubly Degradable Polymer Properties

The doubly degradable polymer in accordance with one or more embodiments may include two degradable bonds. The degradable bonds may be an imine and an ester. The number of ester groups may be in excess relative to the number of imine groups. The ratio of the number of ester groups to number of imine groups may be in a range of from 2:1 to 10:1. In one or more embodiments, the ratio of ester groups to imine groups may be about 6:1.

In one or more embodiments, the doubly degradable polymer may have a molecular weight in a range from about 1,000 g/mol to about 100,000 g/mol. The doubly degradable polymer may have a molecular weight having a lower limit of any of 1,000 g/mol, 5000, g/mol, 10,000 g/mol, 15, 000 g/mol, 20,000 g/mol, 25,000 g/mol, 30,000 g/mol, 35,000 g/mol, 40,000 g/mol, or 45,000 g/mol, to an upper limit of any of 50,000 g/mol, 55,000 g/mol, 60,000 g/mol, 65,000 g/mol, 70,000 g/mol, 75,000 g/mol, 80,000 g/mol, 85,000 g/mol, 90,000 g/mol, 95,000 g/mol, or 100,000 g/mol.

### Doubly Degradable Polymer Synthesis

The present disclosure also relates to a method of preparing a doubly degradable polymer composition.

In one or more embodiments, the method may include polymerizing lactone monomers to form a polylactone polymer, reacting an aliphatic amine with an aromatic aldehyde to form a bis-imine compound, and reacting the polylactone polymer with the bis-imine compound in the presence of a polymerizing agent to incorporate imine functional groups into the polylactone.

The synthesis of aliphatic polyesters may involve a chain growth polymerization via the ring-opening polymerization (ROP) of the corresponding cyclic monomers, which may result in aliphatic polyesters as the final product. Schematic representations of exemplary cyclic ester monomers and their corresponding biodegradable polymers in one or more embodiments are represented by the equations (I) and (II):

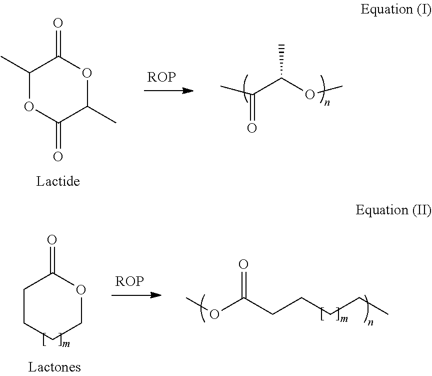

where m ranges from between about 7 to about 17 and n ranges from between about 50 to about 200.

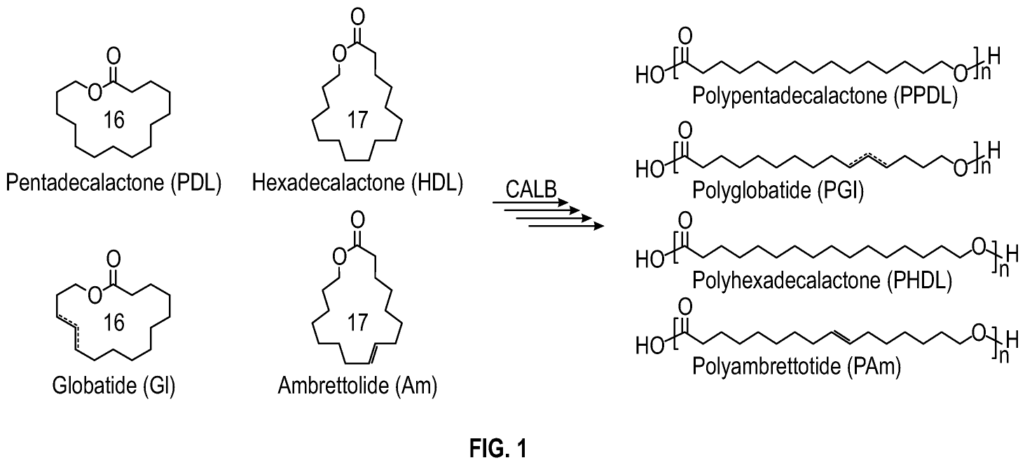

Unlike small and medium lactones, the low level of ring strain in macrolactones may make the ring-opening polymerization of macrolactones more challenging. Only a few metal catalysts, enzymes, and organic catalysts have been reported as being capable of promoting the ring-opening polymerization of macrolactones in order to achieve high conversion to the corresponding aliphatic ester polymer. FIG. 1. is a schematic showing reaction schemes to synthesize polymers that may obtained from the enzymatic ring-opening polymerization of macrolactones using an enzyme catalyst Candida Antarctica:lipase B (CALB).

Phosphazene superbases (PSBs) are organic catalysts that may be used to facilitate the efficient ring-opening polymerization of macrolactones. PSBs have strong basicity, a non-nucleophilic character, good solubility in numerous organic solvents, and a high degree of thermal stability.

In one or more embodiments, phosphazene superbases may be used as a catalyst for the ring-opening polymerization of macrolactones to form polymacrolactones. Suitable phosphazenes include but are not limited to tetrameric triaminoiminophosphorane.

In accordance with embodiments of the present disclosure, the ring-opening polymerization may be a solution polymerization at a temperature between 50° C. and 100° C. in an inert environment in the presence of a nonpolar solvent. Suitable solvents include but are not limited to THF or toluene. The polymerization temperature is selected based on the number of carbons in the lactone ring. A lactone ring with more carbon atoms may require a higher temperature because it has less ring strain making it more stable. The polymerization temperature in one or more embodiments may have a lower limit of one of 50° C., 55° C., 60° C., 65° C., and 70° C. and an upper limit of one of 75° C., 80° C., 85° C., 90° C., 95° C., and 100° C.

In accordance with one or more embodiments of the present disclosure, the ring-opening polymerization may be quenched using a carboxylic acid. The carboxylic acid in one or more embodiments may be dissolved in an alcohol. Any suitable carboxylic acid may be used, and in particular embodiments, acetic acid dissolved in methanol may be used to quench the reaction. In one or more exemplary embodiments, a mixture of 10% of acetic acid and 90% of methanol (by volume) may be used to quench the reaction. The quenched reaction mixture may then be cooled to room temperature.

The molecular weight of the polymacrolactone polymer may be determined in one of more embodiments to monitor the progression of the polymerization by gel permeation chromatography or nuclear magnetic resonance spectroscopy. The target molecular weight of the polymacrolactone is in the range of between about 1,000 g/mol to about 100,000 g/mol.

As noted above, a bis-imine compound may be reacted with a polymacrolactone to form a doubly degradable polymer in accordance with the present disclosure. In one or more embodiments, the bis-imine compound may be formed from the reaction between an aromatic aldehyde and an aliphatic amine. This condensation reaction may proceed favorably in polar or nonpolar solvents and water is the only byproduct.

In one or more embodiments of the present disclosure, the amine may be aliphatic. Examples of the aliphatic amine may include, but are not limited to, 2-(2-aminoethoxy)ethanol.

In one or more embodiments of the present disclosure, examples of the aromatic aldehyde may include, but are not limited to terephthalaldehyde, 2-pyridine carboxaldehyde, 4-pyridine carboxaldehyde, and so on.

In accordance with embodiments of the present disclosure, the reaction between aromatic aldehyde and aliphatic amine may occur in toluene at a temperature less than 5° C. The reaction temperature may have a lower limit of one of −10° C., −9° C., −8° C., −7° C., −6° C., −5° C., −4° C. and −3° C. and an upper limit of one of −2° C., −1° C., 0° C., 1° C., 2° C., 3° C., 4° C., and 5° C. The reaction between an aromatic aldehyde and an aliphatic amine may occur in the presence of the absence of a solvent.

In one or more embodiments, the double-degradable polymer is synthesized via a reaction between a polymacrolactone and a bis-imine compound with the aid of a polymerizing agent. A mixture of the polymacrolactone and the bis-imine compound may be heated in one or more embodiments to melt the solid reactants in an inert environment. The reaction temperature may have a range from about 100° C. to about 200° C. The reaction temperature may have a lower limit of one of 100° C., 110° C., 120° C., 130° C. and 140° C. and an upper limit of one of 150° C., 160° C., 170° C., 180° C., 190° C. and 200° C., where any lower limit may be paired with any mathematically compatible upper limit.

In accordance with embodiments of the present disclosure, the polymacrolactone is in an excess relative to the bis-imine compound. The weight ratio of polymacrolactone to bis-imine compound may be in a range of from 5:1 to 20:1. The weight ratio of polymacrolactone to bis-imine may influence the rate of degradation, therefore, a person of ordinary skill in the art, with the benefit of this disclosure, may be able to select an appropriate ratio.

A polymerizing agent dissolved in a solvent may be gradually added to the melted reactants to initiate polymerization. The molar ratio of the polymerizing agent to bis-imine compound in one or more embodiments may be in a range of from about 1:5 to 5:1. In one or more embodiments, the polymerizing agent may be a diisocyanate, meaning a compound having two isocyanate functional groups. One carbonyl group on the diisocyanate molecule may react with an alcohol group on the end of the polymacrolactone, and the other carbonyl group on the diisocyanate may react with an alcohol group on the bis-imine compound to incorporate imine groups in between polymeric units of the polymacrolactone, resulting in a doubly degradable polymer.

A suitable diisocyanate in one or more embodiments of the present disclosure may be hexamethylenediisocyanate. The reaction may be conducted at a suitable temperature ranging from about 50° C. to about 100° C. The reaction temperature may have a lower limit of one of 50° C., 55° C., 60° C., 65° C. and 70° C. and an upper limit of one of 75° C., 80° C., 85° C., 90° C., 95° C. and 100° C., where any lower limit may be paired with any mathematically compatible upper limit. The reaction time in one or more embodiments may depend on the macrolactone used. The polymerizing agent dissolved in a solvent may be added to the reaction mixture over period of time ranging from about 5 minutes to about 60 minutes depending on the macrolactone used.

The solvent during the polymerization process in one or more embodiments may be a nonpolar solvent such as toluene.

In one or more embodiments of the present disclosure, the reaction time between the polymacrolactone, the bis-imine component, and the polymerizing agent may be in the range from between about 7 hours to about 48 hours. As will be appreciated by those skilled in the art, the reaction time may depend on the type of lactone used. The presence or absence of reactants by NMR may be used to monitor the reaction progression.

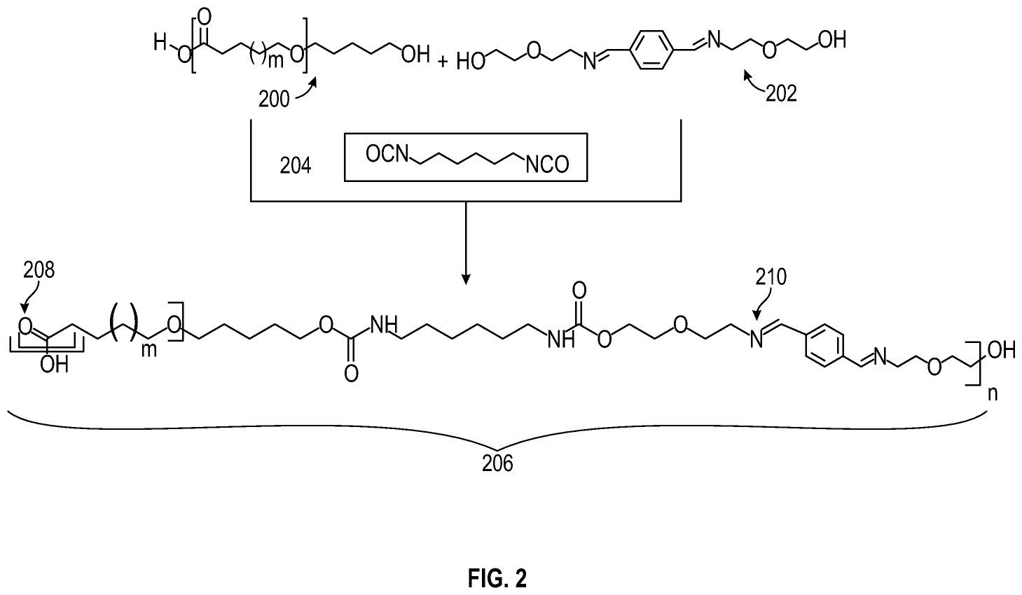

FIG. 2 is a schematic of reaction scheme to synthesize a doubly degradable polymer composition 206 in accordance with one or more embodiments. The reaction scheme shows a polymacrolactone 200 that reacts with a bis-imine compound 202 in the presence of a polymerizing agent, which is a diisocyanate polymerizing agent 204 in the embodiment shown in FIG. 2. The resultant doubly degradable polymer composition 206 includes an ester bond 208 and an imine bond 210. The doubly degradable polymer composition 206 may include multiple imine functional groups incorporated by the addition of bis-mine 202 into the polymacrolactone 200 backbone. The polymacrolactone 200 may be connected to the bis-imine 202 via an amide bond from the diisocyanate polymerizing agent 204 by. The imine bonds may be thermodynamically stable and may maintain the molecular weight and the mechanical strength of the polymacrolactone. Thus, all polymer characteristics may be maintained.

### Polymer Degradation Mechanism

The present disclosure further relates to the mechanism of degradation of the doubly degradable polymer composition. The doubly degradable polymer composition may degrade by the cleavage of two types of covalent bonds to produce an aldehyde and an amine. The doubly degradable polymer comprises an aliphatic polyester with imine functional groups, and therefore contains ester bonds and imine bonds.

In one or more embodiments, the doubly degradable polymer may hydrolyze upon exposure to water. In yet another embodiment, the doubly degradable polymer may degrade upon exposure to an elevated temperature of between 40° C. to 110° C. Exposing the doubly degradable polymer composition to soil in accordance to one or more embodiments may also degrade at least one cleavable covalent bond. Under such conditions, the doubly degradable polymer may degrade to a measurable extent (meaning a change in thickness and/or weight loss may be measured) on a timescale on the order of days to months.

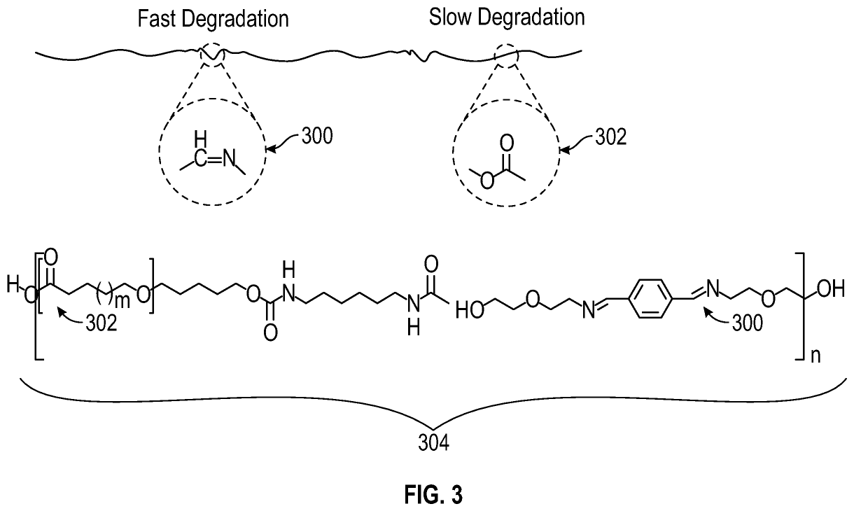

FIG. 3. shows that the doubly degradable polymer 304 in accordance with one or more embodiments has two types of cleavable bonds. The two cleavable bonds hydrolyze at different rates. In particular, the imine bond 300 degrades faster than the ester bond 302. The ester groups 302 in polymacrolactones may undergo hydrolysis to form macrolactone monomers in water resulting in the degradation of the polymacrolactone polymer. Generally, the degradation may occur over a period of 2-8 weeks.

The degradation of polymacrolactones of the present disclosure may be further enhanced due to the presence of imine functional groups 300. The imine functional groups in the polymacrolactones may undergo hydrolysis to break the polymacrolactone into monomers and/or oligomers. The rate of degradation may be controlled by controlling the number of imine functional groups. Generally, the degradation may occur over a period of several minutes to several days.

### EXAMPLES

The following examples are merely illustrative and should not be interpreted as limiting the scope of the present disclosure.

### Materials

Pendadecalactone monomer, 1,4-butanedial, dry toluene, acetic acid/methanol solution, terephthalaldehyde, 2-(2-aminoethoxy)ethanol, and hexamethyl diisocyanate were purchased from Sigma Aldrich. All chemicals were purchased with the highest purity available.

### Preparation of Polymacrolactone

In an inert environment, 1.08 g of the pentadecalactone macrolactone monomer (4.2 mmol), 4.6 μL of 1,4-butanediol (45 μmol), 56 μL (45 μmol) of t-BuP₄ solution and 4.6 mL of dry toluene were added into a round bottom flask. The flask was sealed by a stopcock and stirred in a preheated oil bath at 80° C. The reaction was monitored by proton NMR. The NMR analysis displays two distinctive peaks for macrolactone monomer and polymacrolactone. The reaction was subsequently quenched with dry CH₃COOH/MeOH (10 vol %) and cooled to room temperature.

### Preparation of Bis-Imine Compound

13.4 g (0.10 moles) of terephthalaldehyde and 150 mL of toluene were added into a round bottom flask with a Dean-Stark trap and a condenser. The reaction mixture was stirred and cooled to below 5° C. for 30 minutes. 22 g of 2-(2-aminoethoxy)ethanol (TCI) was added dropwise to the flask over 30 min. After that, the mixture was refluxed until there was no more water formation. The mixture was then cooled to room temperature and filtered to collect the precipitate. The precipitate was washed with 200 ml of toluene. The solid obtained was dried overnight under a nitrogen atmosphere at 50° C.

### Preparation of Doubly Degradable Polymer

200 g of polymacrolactone and 20 g bis-imine compound were added to 300 mL flask equipped with a condenser, a thermometer and stirrer.

The mixture was then melted at a temperature of 130° C. under Argon, and 1% dibutyltin(IV) dilaurate toluene solution was added. Next, 20 g of hexamethylene diisocyanate (HDI) was added dropwise over 10 min and then HDI that remained in the dropping funnel was rinsed with toluene. After continuing the reaction at 130 ° C. under Ar for 4 hours, the corresponding doubly degradable polymer was formed.

### Degradation of Doubly Degradable Polymer

The degradation of the doubly degradable polymer was measured at room temperature and at 40° C. over a period of 30 days. The degradation was measured by measuring the film thickness degradation or weight loss.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112(f) for any limitations of any of the claims herein, except for those in which the claim expressly uses the words ‘means for’ together with an associated function.

What is claimed:

1. A doubly degradable polymer composition, comprising:
one or more aliphatic polyesters; and
one or more imine functional groups;
wherein the one or more imine functional groups are incorporated into the aliphatic polyester backbone.

2. The doubly degradable polymer composition of claim 1, wherein the one or more aliphatic polyesters are selected from the group consisting of a polylactone, a polylactic acid, and combinations thereof.

3. The doubly degradable polymer composition of claim 2, wherein the polylactone is formed from a macrolactone.

4. The doubly degradable polymer composition of claim 3, wherein the macrolactone is selected from the group consisting of pentadecalactone, hexadecalactone, and combinations thereof.

5. The doubly degradable polymer composition of claim 1, wherein the imine functional group is in a bis-imine compound.

6. The doubly degradable polymer composition of claim 1, wherein the doubly degradable polymer is a dynamer.

7. A method of preparing a doubly degradable polymer, comprising:
polymerizing one or more lactone monomers to form a polylactone polymer; and
reacting the polylactone polymer with a bis-imine compound to incorporate one or more imine functional groups into a backbone of the polylactone polymer.

8. The method of claim 7, further comprising, prior to reacting the polylactone polymer with the bis-imine compound, reacting an aromatic aldehyde with an aliphatic amine to form the bis-imine compound.

9. The method of claim 8, wherein the aromatic aldehyde is terephthalaldehyde.

10. The method of claim 8, wherein the aliphatic amine is 2-(2-aminoethoxy)ethanol.

11. The method of claim 7, wherein the lactone monomer is a macrolactone selected from the group consisting of pentadecalactone, hexadecalactone, and combinations thereof.

12. The method of claim 7, wherein a polymerization of one or more lactones is carried out at a temperature from between 50° C. to 100° C.

13. The method of claim 7, wherein a polymerization of one or more lactones is carried out in a nonpolar solvent.

14. The method of claim 7, wherein a polymerization of one or more lactones is carried out in an inert environment.

15. The method of claim 7, wherein reacting the polylactone with the bis-imine compound is carried out at a temperature from between 100° C. to 180° C.

16. The method of claim 7, wherein reacting the polylactone with the bis-imine compound is carried out in a solvent, wherein the solvent is toluene.

17. The method of claim 7, wherein reacting the polylactone with the bis-imine compound is carried out in an inert environment.

18. The method of claim 7, wherein reaction the polylactone with the bis-imine compound is carried out for between 2 to 6 hours.

19. A method of degrading a doubly degradable polymer composition, comprising:
providing a doubly degradable polymer composition comprising one or more ester functional groups and one or more imine functional groups; and
exposing the doubly degradable polymer composition to at least one of water, an elevated temperature, and soil, thereby hydrolyzing at least one cleavable covalent bond to produce an aldehyde and an amine.

20. The method of claim 19, wherein the elevated temperature is between 40° C. to 110° C.
